(19) United States
(12) Patent Application Publication
(10) Pub. No.: US 2026/0021833 A1
(43) Pub. Date: Jan. 22, 2026

(54) DIRECTING TRAFFIC ASSISTANCE SKILL

(71) Applicant: AUTOBRAINS TECHNOLOGIES LTD, Tel Aviv-Yafo (IL)

(72) Inventor: Hadas ELKABIR, Tel Aviv-Yafo (IL)

(73) Assignee: AUTOBRAINS TECHNOLOGIES LTD, Tel Aviv-Yafo (IL)

(21) Appl. No.: 18/773,590

(22) Filed: Jul. 16, 2024

(51) Int. Cl. B60W 60/00

(52) U.S. Cl. CPC B60W 60/0059; G06V 40/10; G06V 40/20; B60W 2050/146; B60W 60/001; G06V 10/77

(57) ABSTRACT

A method for non-verbal traffic-directed human communication, that includes obtaining a sensed information unit that captures a non-verbal communication attempt made by a person in relation to a vehicle; determining whether the non-verbal communication attempt conveys a legally binding driving related command, by processing, using a machine learning process, the sensed information; automatically generating instructions executable by a man machine interface controller, in accordance with the determination; and providing, based on the generated instructions, at least one of a human perceivable, and machine-perceivable indication regarding the legally binding driving related command.

### BACKGROUND

Vehicle sensor may catch a non-verbal communication attempt made by a person located within the environment of the vehicle. While a policemen may use non-verbal communication to stop the vehicle, another person, erroneously identified as a policeman may cause the vehicle to stop-which may endanger the vehicle.

### SUMMARY

A method, system and non-transitory computer readable medium as illustrated in the application.

### A BRIEF DESCRIPTION OF THE DRAWINGS

The embodiments of the disclosure will be understood and appreciated more fully from the following detailed description, taken in conjunction with the drawings in which:

FIG. 1 illustrates an example of a vehicle;

FIG. 2 illustrates an example of a method; and

FIG. 3 illustrates an example of a scene.

### DETAILED DESCRIPTION

The different figures illustrates examples of units and/or software and/or

information items and/or steps and/or components. These examples are provided for brevity of explanation. At least one of the units and/or software and/or information items and/or steps and/or components is optional or mandatory.

According to an embodiment there is provided a method, a non-transitory computer readable medium and a computerized system for directing traffic assistance skill.

According to an embodiment there is provided a method for non-verbal traffic-directed human communication.

According to an embodiment, the method uses a machine learning process trained to identify non-verbal communication attempt conveys a legally binding driving related command, and to distinguish between a non-verbal communication attempt conveys a legally binding driving related command and a non-verbal communication attempt that does not convey a legally binding driving related command. The machine learning process may be trained in any manner-supervised learning, self-supervised learning, unsupervised learning, and the like.

According to an embodiment, an identification of the non-verbal communication attempt conveys a legally binding driving related command is followed by responding to the identification.

According to an embodiment, the responding may include generating instructions to be executed by a man machine interface or by another computerized unit of a vehicle.

A policemen is an example of an authorized person that is authorized to issue a legally binding driving related command-especially such as command related to driving a vehicle. Any reference to a policemen should be applied mutatis mutandis to any other authorized person such as but not limited to a soldier, a security guard, a municipal worker, and the like.

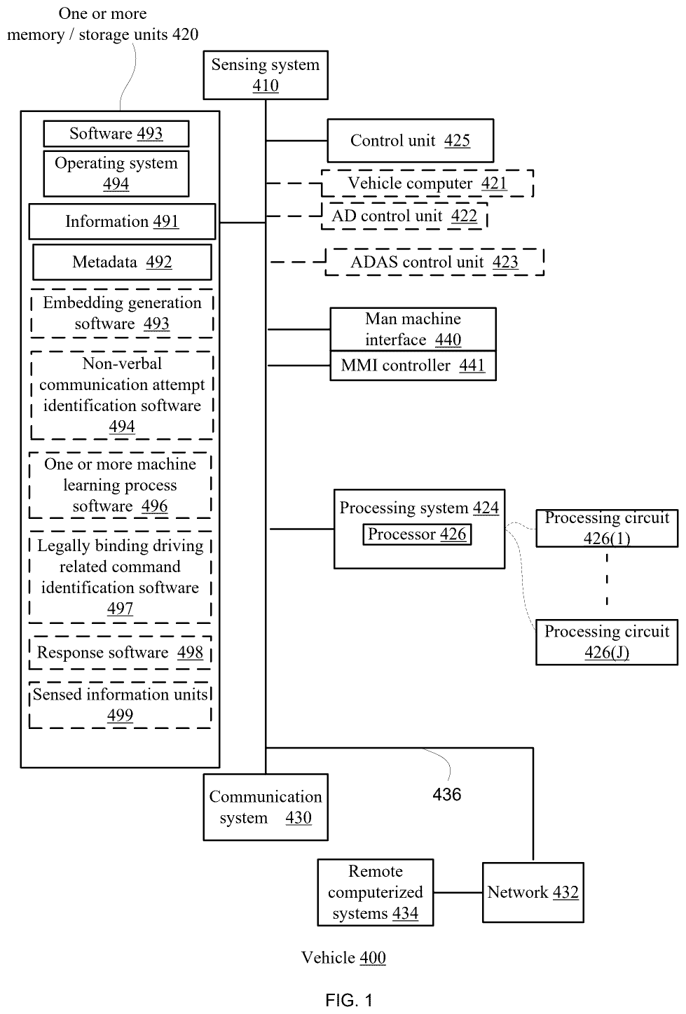

FIG. 1 illustrates an example of a vehicle 400.

Vehicle 400 includes a man machine interface 440 having or being in communication with man machine interface (MMI) controller 441, a communication system 430, one or more memory and/or storage units 420, a processing system 424 including processor 426. The communication system 430, the one or more memory and/or storage units 420, and the processing system 424 may belong to a computerized system of vehicle 400. The computerized system may be a server, a laptop, a desktop or any other computer and may include or be in communication with a sensing unit and/or a controller.

According to an embodiment, vehicle 400 is in communication with network 432 and one or more other remote computerized systems 434 that are in communication with network 432. An example of a remote computerized system is a server or one or more computers having access to a storage system that stores items related to one or more portions of one or more groups of neural networks—at least some of which are not currently stored in the vehicle.

According to an embodiment, the communication system 430 is configured to enable communication between the one or more memory and/or storage units 420 and/or any one of the additional units and/or the network 432 (that is in communication with the remote computerized systems). Communication system 430 is also configured to enable communication with other elements such as sensing system 410, man machine interface 440, control unit 425, vehicle computer 421, autonomous driving control unit 422 (denoted AD control unit), advanced driver assistance system (ADAS) control unit 423 (denoted ADAS control unit), and the like.

The memory and/or storage units 420 was shown as storing software. Any reference to software should be applied mutatis mutandis to code and/or firmware and/or instructions and/or commands, and the like.

Processor 426 includes a plurality of processing units 426(1)-426(J), J is an integer that exceeds one. Any reference to one unit or item should be applied mutatis mutandis to multiple units or items. For example—any reference to processor should be applied mutatis mutandis to multiple processors, any reference to communication system 430 should be applied mutatis mutandis to multiple communication systems.

According to an embodiment, the one or more memory and/or storage units 420 includes one or more memory unit, each memory unit may include one or more memory banks.

According to an embodiment, the one or more memory and/or storage units 420 includes a volatile memory and/or a non-volatile memory. The one or more memory and/or storage units 420 may be a random-access memory (RAM) and/or a read only memory (ROM).

According to an embodiment, the non-volatile memory unit is a mass storage device, which can provide non-volatile storage of computer code, computer readable instructions, data structures, program modules, and other data for the processor or any other unit of vehicle. For example, and not meant to be limiting, a mass storage device can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any content may be stored in any part or any type of the memory and/or storage units.

According to an embodiment, the at least one memory unit stores at least one database—such as any database known in the art-such as DB2®, Microsoft® Access, Microsoft® SQL Server, Oracle®, mySQL, PostgreSQL, and the like.

The memory and/or storage units 420 are configured to store firmware and/or software, one or more operating systems, data and metadata required to the execution of any of the methods mentioned in this application.

The memory and/or storage units 420 was shown as storing software. Any reference to software should be applied mutatis mutandis to code and/or firmware and/or instructions and/or commands, and the like.

Various units and/or components are in communication with each other using any communication elements and/or protocols. An example of a communication system is denoted 430. Other communication elements may be provided.

The communication system 430 may be in communication with bus 436. The bus represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus, and all buses specified in this description can also be implemented over a wired or wireless network connection and each of the subsystems.

Network 432 that is located outside the vehicle and is used for communication between the vehicle and at least one remote computing system. By way of example, a remote computing system can be a personal computer, a laptop computer, portable computer, a server, a router, a network computer, a peer device or other common network node, and so on. Logical connections between the processor and either one of remote computing systems can be made via a local area network (LAN) and a general wide area network (WAN). Such network connections can be through a network adapter (may belong to communication system 430) which can be implemented in both wired and wireless environments. Such networking environments are conventional and commonplace in offices, enterprise-wide computer networks, intranets, and a larger network such as the internet.

It should be noted that at least a part of the content illustrated as being stored in one or more memory/storage units 420 may be stored outside the vehicle. It should also be noted that the processor may evaluate signatures generated by a plurality of detectors.

Examples of generating signatures and/or cropping images are provided in U.S. patent application Ser. No. 18/527,701 which is incorporated herein by reference.

According to an embodiment, the memory and/or storage units 420 stores at least one of: operating system 494, information 491 such as sensed information units 499, metadata 492, and software 493.

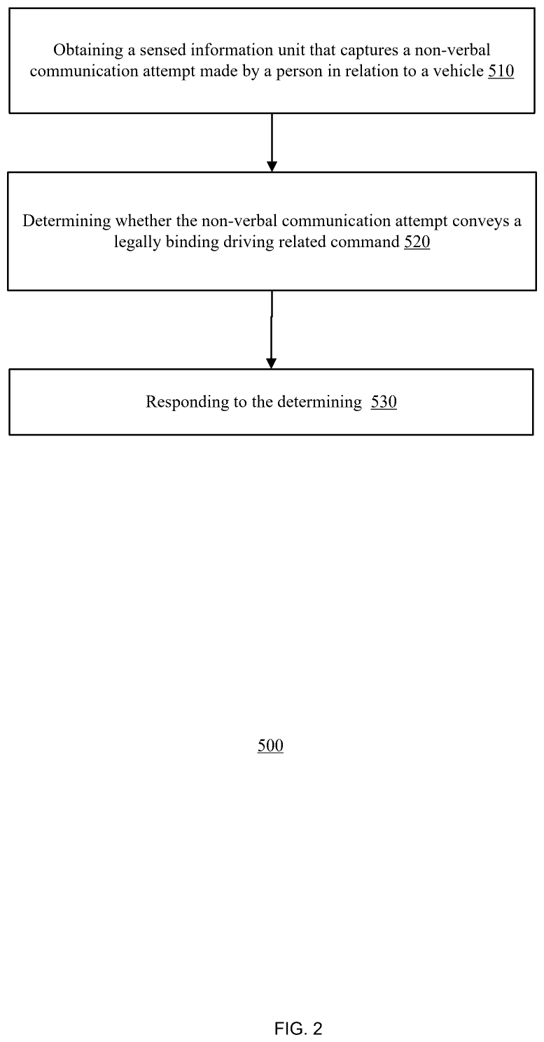

Examples of software includes:
A. Non-verbal communication attempt identification software 495 configured to execute, at least in part, step 510 of FIG. 2.
B. One or more machine learning process software 496 configured to execute, at least in part, method 500 of FIG. 2.
C. Legally binding driving related command identification software 497 configured to execute, at least in part, step 520 of FIG. 2.
D. Response software 498 configured to execute, at least in part, step 530 of FIG. 2.

The control unit 425 may cooperate with ADAS control unit 423 and/or with AD control unit 482 and/or may control or communicate with other vehicle components-including vehicle computer.

The ADAS control unit 423 is configured to control ADAS operations.

The AD control unit 422 is configured to control autonomous driving of the autonomous vehicle.

The vehicle computer 421 is configured to control the operation of the vehicle-especially controlling the engine, the transmission, and any other vehicle system or component.

The vehicle computer 421 may be in communication with an engine control module, a transmission control module, a powertrain control module, and the like.

The sensing system 410 may include optics, a sensing element group, a readout circuit, and an image signal processor. Optics are followed by a sensing element group such as line of sensing elements or an array of sensing elements that form the sensing element group. The sensing element group is followed by a readout circuit that reads detection signals generated by the sensing element group. An image signal processor is configured to perform an initial processing of the detection signals—for example by improving the quality of the detection information, performing noise reduction, and the like. The sensing system 410 is configured to output one or more sensed information units (SIUs).

The control unit 425 is configured to control the operation of the sensing system 410, and/or the one or more memory and/or storage units 420 and/or the one or more additional units (except the controller).

By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by a computer.

Any content may be stored in any part or any type of the memory and/or storage units.

According to an embodiment, the at least one memory unit stores at least one database—such as any database known in the art—such as DB2®, Microsoft® Access, Microsoft® SQL Server, Oracle®, mySQL, PostgreSQL, and the like.

Various units and/or components are in communication with each other using any communication elements and/or protocols. An example of a communication system is denoted 430. Other communication elements may be provided.

According to an embodiment, processing system 424 is configured to perform, while executing software and:
A. Receive a sensed information unit that captures a non-verbal communication attempt made by a person in relation to a vehicle.
B. Determining whether the non-verbal communication attempt conveys a legally binding driving related command, by processing the sensed information unit.
C. Respond to the determining.

FIG. 2 illustrates an example of method 500 for non-verbal traffic-directed human communication.

According to an embodiment, method 500 includes step 510 of obtaining a sensed information unit that captures a non-verbal communication attempt made by a person in relation to a vehicle.

According to an embodiment, the identification of the non-verbal communication attempt is made by a machine learning process.

According to an embodiment, the identification of the non-verbal communication attempt is made by any non-machine learning process-such as a rule based analysis of the sensed information unit.

According to an embodiment, the sensed information unit may be sensed by sensing unit 410 of FIG. 1 and may be an image, multiple images, a video stream, a portion of an image, and the like.

According to an embodiment, the sensed information unit is designed to capture data regarding the non-verbal communication attempt made by a person. This is for facilitating interaction between a person and a vehicle through non-verbal means. The vehicle sensing unit plays a role here, as it is responsible for catching a non-verbal communication attempt made by a person located within the environment of the vehicle. The sensing unit catching a non-verbal communication attempt is to interpret the intentions of a person, such as a policeman, who is trying to communicate with the vehicle without using verbal commands. The non-verbal communication attempt is intended to convey a message or command without using words, directed towards a vehicle or its operator. The vehicle sensor's role is to detect these communication attempts, ensuring that the vehicle can respond appropriately. This is in scenarios involving policemen, who may use non-verbal communication to stop the vehicle. However, there is a risk that another person, erroneously identified as a policeman, may cause the vehicle to stop, which could endanger the vehicle.

This highlights the importance of accurately interpreting non-verbal cues to prevent unintended stops and potential hazards. The sensed information unit's capturing of the non-verbal communication attempt is for the subsequent steps in the method. It provides the data for processing and determining whether the non-verbal communication attempt conveys a legally binding driving-related command. This determination is made using a machine learning process, which further underscores the importance of accurately capturing the initial non-verbal communication attempt.

In summary, step 510 involves the initial capture of non-verbal communication attempts by a vehicle sensor, which is for interpreting the intentions of individuals, such as policemen, and ensuring the vehicle responds appropriately to non-verbal commands. This step sets the foundation for the subsequent processing and determination of the legality and intent of the communication, ultimately leading to the generation of executable instructions and indications for the vehicle.

According to an embodiment, step 510 is followed by step 520 of determining whether the non-verbal communication attempt conveys a legally binding driving related command, by processing, using a machine learning process, the sensed information unit.

According to an embodiment, the identification of the non-verbal communication attempt is made by the non-machine learning process used in step 520.

According to an embodiment, the identification of the non-verbal communication attempt is made by the non-machine learning process that differs from the machine learning process that is used for step 520.

According to an embodiment, step 520 includes at least one of:
A. Processing, by the machine learning process, additional sensed information units captured in an environment of the vehicle, such that determining whether the non-verbal communication attempt conveys the legally binding driving related command is further based on the processed additional sensed information units.
B. Identifying the person as being authorized to provide the legally binding driving related command. According to an embodiment the authorized person is a policemen, a soldier, a security guard, a municipal worker, and the like.

According to an embodiment, step 520 is for ensuring that the vehicle correctly interprets non-verbal cues, particularly those from authorized personnel like policemen, to avoid potential hazards. The legally binding driving-related command is a directive that has legal authority in the context of driving and traffic regulations, such as a stop signal from a policeman. The machine learning process is employed to process the sensed information and determine the content and intent of the non-verbal communication attempt. Step 520 assists in ensuring that the vehicle responds appropriately to commands that are legally binding and intended to ensure safety and compliance with traffic regulations.

The machine learning process is integral to this step as it processes the sensed information to ascertain if it conveys a legally binding driving-related command. This involves detecting communication attempts and initiating a stop command if the non-verbal communication is identified as such.

The mention of policemen in the context of non-verbal communication is to illustrate a scenario where the sensing unit should correctly interpret the non-verbal cues to stop the vehicle as intended by an authorized person like a policeman. However, there is also a risk associated with the vehicle stopping due to misidentification of a person as a policeman, which could lead to endangering the vehicle. This highlights the importance of accurate interpretation by the machine learning process to avoid unintended stops and potential hazards. In summary, step 520 involves a detailed process where the sensing unit detects non-verbal communication attempts, and the machine learning process determines whether these attempts convey legally binding driving-related commands. This ensures that the vehicle responds correctly to authorized non-verbal signals, particularly from policemen, while mitigating the risk of misinterpretation and unintended stops.

According to an embodiment, step 520 is followed by step 530 of responding to the outcome of step 520.

According to an embodiment, when the determining that the non-verbal communication attempt conveys a legally binding driving related command, the responding includes at least one out of:
A. Automatically generating instructions executable by a man machine interface controller, in accordance with the determination.
B. Automatically providing instructions executable by a man machine interface controller, in accordance with the determination. The providing may include storing at a location accessible to the man machine interface controller, transmitting the instructions to the man machine interface controller, sending an indication about the generation of the instructions to the man machine interface controller. Non-limiting instructions are listed in C-E.
C. Automatically generating instructions executable by a man machine interface controller, in accordance with the determination to notify a human driver, by a man machine interface, about the content of the legally binding driving related command.
D. Automatically generating instructions executable by a man machine interface controller, in accordance with the determination to suggest a human driver, by a man machine interface, a suggested response to the legally binding driving related command—for example ignore, comply, delay the compliance, any risk associated with immediately complying with the legally binding driving related command, perform a certain driving operation, and the like.
E. Notifying a human driver, in accordance with the determination and by a man machine interface, about the content of the legally binding driving related command.
F. Providing a human driver, by a man machine interface and in accordance with the determination, a suggested response to the legally binding driving related command—for example ignore, comply, delay the compliance, any risk associated with immediately complying with the legally binding driving related command, perform a certain driving operation, and the like.
G. Automatically generating a machine-perceivable indication about the legally binding driving related command.
H. Providing the machine-perceivable indication about the legally binding driving related command.
I. Automatically generating instructions executable by another controller of the vehicle, in accordance with the determination. The other controller is configured to control a driving related operation such as a manner of propagating the vehicle, a manner of navigating the vehicle, an execution of an autonomous driving operation, an execution of an advance driver assistance system (ADAS) operation, a manner in which one of the components of the vehicle operates, a determination or suggestion of who shall control the vehicle—the human driver or an autonomous driving unit. Control unit 425, vehicle computer 421, AD control unit 422 and ADAS control unit 423 are examples of another controller.
J. Automatically providing instructions executable by the other controller, in accordance with the determination. The providing may include storing at a location accessible to the other controller, transmitting the instructions to the other controller, sending an indication about the generation of the instructions to the man machine interface controller. Non-limiting instructions are listed in
K. Instructing or suggesting the other controller to control a driving related operation of the vehicle in accordance with the determination.
L. Instructing or suggesting the other controller to control a manner of propagating the vehicle in accordance with the determination.
M. Instructing or suggesting the other controller to control a manner of navigating the vehicle in accordance with the determination.
N. Instructing or suggesting the other controller to control an execution of an autonomous driving operation in accordance with the determination.
O. Instructing or suggesting the other controller to control an execution of an advance driver assistance system (ADAS) operation in accordance with the determination.
P. Instructing or suggesting the other controller to control a manner in which one of the components of the vehicle operates in accordance with the determination.
Q. Instructing or suggesting the other controller to control a determination or suggestion of who shall control the vehicle in accordance with the determination.
R. Instructing or suggesting the other controller to control a driving related operation of the vehicle in accordance with the determination.
S. Controlling a manner of propagating the vehicle in accordance with the determination.
T. Controlling a manner of navigating the vehicle in accordance with the determination.
U. Controlling an execution of an autonomous driving operation in accordance with the determination.
V. Controlling an execution of an advance driver assistance system (ADAS) operation in accordance with the determination.
W. Controlling a manner in which one of the components of the vehicle operates in accordance with the determination.
X. Controlling a determination or suggestion of who shall control the vehicle in accordance with the determination.
Y. Controlling a manner of navigating the vehicle in accordance with the determination.
Z. Executing an autonomous driving operation in accordance with the determination.
AA. Executing an ADAS operation in accordance with the determination.
BB. Performing a control switch between the driver and the autonomous vehicle or between the autonomous vehicle and the driver.

According to an embodiment step 530 of responding is contingent on a human driver response any of the automatically generated instructions. For example—the execution of execution of an autonomous driving operation is contingent on a human driver response to any of the automatically generated instructions.

According to an embodiment step 530 of responding is further based on environmental information other than the non-verbal communication attempt.

According to an embodiment step 530 includes evaluating, based on the environmental information, a risk associated with transitioning a driving of the vehicle in response to the legally binding driving related command.
A. The risk may be impacted by presence and/or behavior of one or more other road users, road conditions, traffic conditions, weather conditions and the like. The risk may be evaluated by the machine learning used during step 520 or by another entity.
B. A risk may represent the chance is being involved in an accident when immediately stopping the vehicle or slowing the vehicle. For example—a distance between the back of the vehicle and a following vehicle, the speed of the following vehicle and/or the presence of an escape route, a presence of close safe stopping location downstream the path of the vehicle, and any other risk or risk mitigation parameter may determine the risk.

According to an embodiment, step 530 involves issuing a delayed response to the legally binding driving related command when the risk exceeds a risk threshold.

According to an embodiment, step 530 includes automatically generating instructions executable by a man-machine interface controller, in accordance with the determination. The action of automatically generating instructions executable by a man-machine interface controller is to generate executable instructions based on the determination of the non-verbal communication attempt. This action is for the system to respond appropriately to the non-verbal cues detected by the vehicle sensor. The man-machine interface controller is responsible for creating actionable steps that can be understood and carried out by the man machine interface, facilitating the interaction between human and machine.

This ensures that the driver can respond to the non-verbal communication attempts in a manner that is both safe and legally compliant. The vehicle is the recipient of these instructions and must respond accordingly. In summary, step 104 involves the generation of executable instructions by the man-machine interface controller based on the determination of the non-verbal communication attempt. This step is for ensuring that the vehicle can respond appropriately to non-verbal cues, particularly those from authorized personnel like policemen, while also mitigating the risk of erroneous stops caused by misidentification.

According to an embodiment, step 530 includes providing feedback or acknowledgment of the non-verbal communication attempt in a form that can be understood by either humans or machines. This is for ensuring that the vehicle responds appropriately to the commands it receives, whether they are intended for human drivers or automated systems. The ‘vehicle’ in this context is the recipient of the non-verbal communication attempt. The sensing unit may catch a non-verbal communication attempt made by a person located within the environment of the vehicle. The sensing unit catching a non-verbal communication attempt is to interpret the intentions of a person, such as a policeman, who is trying to communicate with the vehicle without using verbal commands. This is for the vehicle to understand and respond to commands such as stopping or changing direction. In summary, step 530 also ensures that the vehicle can provide appropriate indications based on the non-verbal communication attempts it detects, thereby facilitating safe and effective interaction between the vehicle and its environment. This step is for the overall functionality of the system, ensuring that the vehicle can respond correctly to legally binding driving-related commands, whether they are intended for human drivers or automated systems.

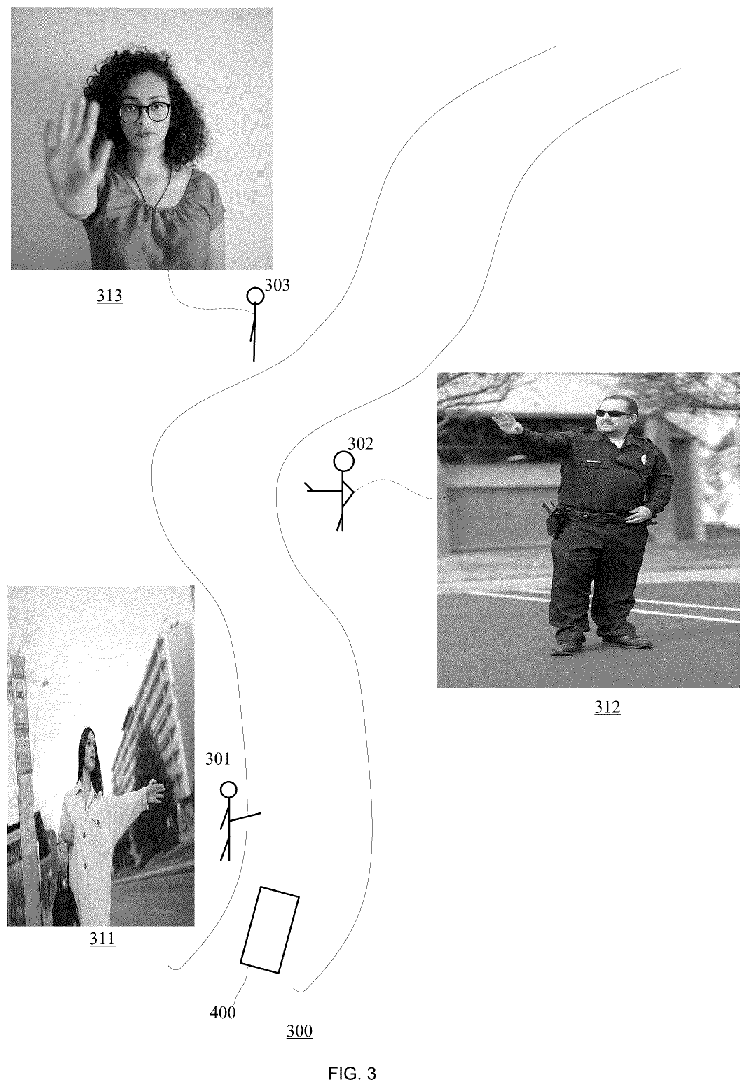

FIG. 3 illustrates an example of a vehicle 400 passing a path and during the passage acquired (a) at a first location, a first sensed information unit 311 capturing a lady 301 non-verbally communicating with the vehicle, (b) at a second location, a second sensed information unit 312 capturing a policemen 302 non-verbally communicating with the vehicle and asking the vehicle to stop, and (c) at a third location, a third sensed information unit 313 capturing another lady 303 non-verbally communicating with the vehicle.

The vehicle is configured to determine that only the policemen communicated a legally binding driving related command—to stop and responds to the stop command.

Any combination of any step of any method illustrated in the application is provided.

In the foregoing detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarding the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a device or system capable of executing the method and/or to a non-transitory computer readable medium that stores instructions for executing the method.

Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

Any combination of any module or unit listed in any of the figures, any part of the specification and/or any claims may be provided.

Any one of transformation module, active learning module, or clustering module, or any other module described herein, may be implemented in hardware and/or code, instructions and/or commands stored in a non-transitory computer readable medium, may be included in a vehicle, outside a vehicle, in a mobile device, in a server, and the like.

The vehicle may be any type of vehicle-such as a ground transportation vehicle, an airborne vehicle, or a water vessel.

The specification and/or drawings may refer to an image. An image is an example of sensed information. Any reference to an image may be applied mutatis mutandis to any type of natural signal such as but not limited to signal generated by nature, signal representing human behavior, signal representing operations related to the stock market, a medical signal, financial series, geodetic signals, geophysical, chemical, molecular, textual and numerical signals, time series, and the like. Any reference to a media unit may be applied mutatis mutandis to sensed information. The sensed information may be of any kind and may be sensed by any type of sensors-such as a visual light camera, an audio sensor, a sensor that may sense infrared, radar imagery, ultrasound, electro-optics, radiography, LIDAR (light detection and ranging), etc. The sensing may include generating samples (for example, pixel, audio signals) that represent the signal that was transmitted, or otherwise reach the sensor.

The specification and/or drawings may refer to a processor. The processor may be a processing circuitry (also referred to as a processing circuit). The processing circuitry may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

Any combination of any steps of any method illustrated in the specification and/or drawings may be provided.

Any combination of any subject matter of any of claims may be provided.

Any combinations of systems, units, components, processors, sensors, illustrated in the specification and/or drawings may be provided.

Any reference to an object may be applicable to a pattern. Accordingly-any reference to object detection is applicable mutatis mutandis to a pattern detection.

A situation may be a singular location, or optionally a combination of properties identified at a specified point in time. A scenario is a series of events that follow logically within a causal frame of reference. Any reference to a scenario should be applied mutatis mutandis to a situation.

The sensed information unit may be sensed by one or more sensors of one or more types. The one or more sensors may belong to the same device or system—or may belong to different devices of systems.

We claim:

1. A method for non-verbal traffic-directed human communication, the method comprises:
obtaining a sensed information unit that captures a non-verbal communication attempt made by a person in relation to a vehicle;
determining whether the non-verbal communication attempt conveys a legally binding driving related command, by processing, using a machine learning process, the sensed information;
automatically generating instructions executable by a man machine interface controller, in accordance with the determination; and
providing, based on the generated instructions, at least one of a human perceivable, and machine-perceivable indication regarding the legally binding driving related command.

2. The method according to claim 1, further comprising automatically generating an instruction for responding to the determination, the instructions are executable by at least one of a man machine interface controller, and another controller of the vehicle.

3. The method according to claim 2, wherein the automatically generating the instructions is further based on environmental information other than the non-verbal communication attempt.

4. The method according to claim 3, further comprising evaluating, based on the environmental information, a risk associated with transitioning a driving of the vehicle in response to the legally binding driving related command.

5. The method according to claim 4, wherein automatically generating the instruction involves issuing a delayed response to the legally binding driving related command when the risk exceeds a risk threshold.

6. The method according to claim 1, further comprising processing, by the machine learning process, additional sensed information units captured in an environment of the vehicle, such that determining whether the non-verbal communication attempt conveys the legally binding driving related command is further based on the processed additional sensed information units.

7. The method according to claim 1, further comprising performing an autonomous driving operation in compliance with the legally binding driving related command.

8. The method according to claim 7, wherein performing an autonomous driving operation is contingent on a human driver response to the automatically generated instructions.

9. The method according to claim 1, wherein the determining comprises identifying the person as being authorized to provide the legally binding driving related command; and identifying the legally binding driving related command.

10. The method according to claim, further comprising identifying the person to be a policemen.

11. A non-transitory computer readable medium for non-verbal traffic-directed human communication, the non-transitory computer readable medium stores commands executable by a processing circuit for:
obtaining a sensed information unit that captures a non-verbal communication attempt made by a person in relation to a vehicle;
determining whether the non-verbal communication attempt conveys a legally binding driving related command, by processing, using a machine learning process, the sensed information;
automatically generating instructions executable by a man machine interface controller, in accordance with the determination; and
providing, based on the generated instructions, at least one of a human perceivable, and machine-perceivable indication regarding the legally binding driving related command.

12. The non-transitory computer readable medium according to claim 11, further storing instructions executable by the processing circuit for automatically generating an instruction for responding to the determination, the instructions are executable by at least one of a man machine interface controller, and another controller of the vehicle.

13. The non-transitory computer readable medium according to claim 12, wherein the automatically generating the instructions is further based on environmental information other than the non-verbal communication attempt.

14. The non-transitory computer readable medium according to claim 13, further storing instructions executable by the processing circuit for evaluating, based on the environmental information, a risk associated with transitioning a driving of the vehicle in response to the legally binding driving related command.

15. The non-transitory computer readable medium according to claim 14, wherein automatically generating the instruction involves issuing a delayed response to the legally binding driving related command when the risk exceeds a risk threshold.

16. The non-transitory computer readable medium according to claim 11, further storing instructions executable by the processing circuit for processing, by the machine learning process, additional sensed information units captured in an environment of the vehicle, such that determining whether the non-verbal communication attempt conveys the legally binding driving related command is further based on the processed additional sensed information units.

17. The non-transitory computer readable medium according to claim 11, further storing instructions executable by the processing circuit for performing an autonomous driving operation in compliance with the legally binding driving related command.

18. The non-transitory computer readable medium according to claim 17, wherein performing an autonomous driving operation is contingent on a human driver response to the automatically generated instructions.

19. The non-transitory computer readable medium according to claim 11, wherein the determining comprises identifying the person as being authorized to provide the legally binding driving related command; and identifying the legally binding driving related command.

20. The non-transitory computer readable medium according to claim 19, further storing instructions executable by the processing circuit for identifying the person to be a policemen.
